(19) United States
(12) Patent Application Publication
(10) Pub. No.: US 2025/0180904 A1
(43) Pub. Date: Jun. 5, 2025

(54) Displays with Adjustable Haze and Tint Layers

(71) Applicant: Apple Inc., Cupertino, CA (US)

(72) Inventor: Jonathan C Moisant-Thompson, San Jose, CA (US)

(21) Appl. No.: 18/909,828

(22) Filed: Oct. 8, 2024

Related U.S. Application Data
(60) Provisional application No. 63/606,535, filed on Dec. 5, 2023.

(51) Int. Cl. G02B 27/01; G02F 1/1334; G02F 1/13363

(52) U.S. Cl. CPC G02B 27/0172; G02F 1/1334; G02F 1/133636; G02F 1/133638; G02B 2027/0178; G02B 2207/101

(57) ABSTRACT

A pair of glasses or other eyewear may include a display that produces display content and an optical system through which the display content is viewable from an eye box. The optical system may include an optical combiner that combines real-world light with the display content. The glasses may be operable in a transparent mode for viewing the environment and a dark mode for viewing display content on the glasses. The optical system may include a light modulator layer such an adjustable tint and haze layer that both darkens and diffuses ambient light when the glasses are being used to view display content in the dark mode. The optical system may be configured to darken ambient light more than display light from external displays so that the user can use electronic devices while wearing the glasses.

This application claims the benefit of U.S. provisional patent application No. 63/606,535, filed Dec. 5, 2023, which is hereby incorporated by reference herein in its entirety.

### BACKGROUND

This disclosure relates to electronic devices and, more particularly, to electronic devices with displays.

Electronic devices can include displays that provide images near the eyes of a user. Such electronic devices often include virtual or augmented reality headsets with displays having optical elements that allow users to view the displays. If care is not taken, the optical elements might not exhibit sufficient levels of optical performance.

### SUMMARY

A head-mounted device such as a pair of glasses or other eyewear may include a display that produces display content and an optical system through which the display content is viewable from an eye box. The optical system may include an optical combiner that combines real-world light with the display content.

The glasses may be operable in a transparent mode for viewing the environment and a dark mode for viewing display content on the glasses. The optical system may include a light modulator layer such an adjustable tint and haze layer that darkens and diffuses ambient light when the glasses are being used to view display content in the dark mode. The optical system may be configured to darken ambient light more than display light from external displays so that the user can use electronic devices while wearing the glasses.

### BRIEF DESCRIPTION OF THE DRAWINGS

FIG. 1 is a diagram of an illustrative electronic device such as a head-mounted device having a display in accordance with some embodiments.

FIG. 2 is a top view of an illustrative electronic device such as a head-mounted device having displays and an optical system for providing real-world light and light from the displays to eye boxes in accordance with some embodiments.

FIG. 3 is a top view of an illustrative optical system having an optical combiner, an adjustable haze layer, and an adjustable tint layer in accordance with some embodiments.

FIG. 4 is a side view of an illustrative optical system having an optical combiner and a combined adjustable tint and haze layer in accordance with some embodiments.

FIG. 5 is a side view of an illustrative optical system having an optical combiner, a combined adjustable tint and haze layer, and a quarter wave plate for suppressing ghost artifacts in accordance with some embodiments.

FIG. 6 is a side view of an illustrative optical system having an optical combiner, a combined adjustable tint and haze layer, and first and second quarter wave plates for suppressing ghost artifacts while maintaining external display viewability in accordance with some embodiments.

FIG. 7 is a side view of an illustrative optical system that includes an optical combiner, an adjustable tint layer, an adjustable haze layer, and first and second quarter wave plates for suppressing ghost artifacts while maintaining external display viewability in accordance with some embodiments.

FIG. 8 is a side view of an illustrative optical system that includes an optical combiner, an adjustable tint layer, an adjustable haze layer, a liner polarizer, and first and second quarter wave plates for suppressing ghost and bloom artifacts while maintaining external display viewability in accordance with some embodiments.

### DETAILED DESCRIPTION

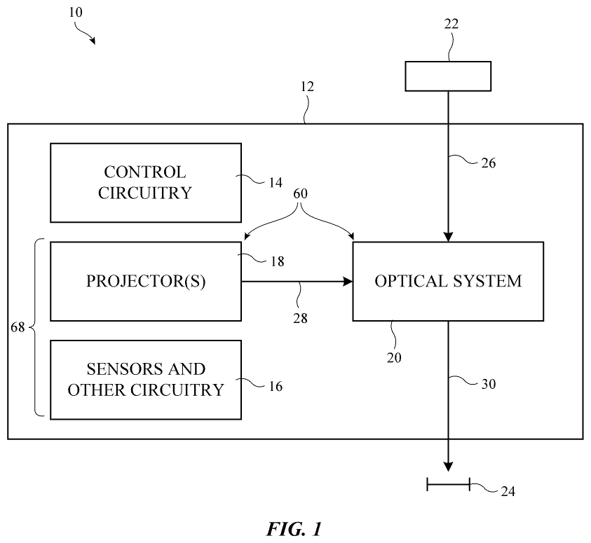

Electronic device 10 of FIG. 1 may be a head-mounted device such as a pair of glasses or other eyewear having one or more displays. The displays in system 10 may include near-eye displays 60 mounted within support structure such as housing 12. Housing 12 may have the shape of a pair of eyeglasses or goggles (e.g., supporting frames), may form a housing having a helmet shape, or may have other configurations to help in mounting and securing the components of near-eye displays 60 on the head or near the eye of a user. Near-eye displays 60 may include one or more display projectors such as projectors 18 (sometimes referred to herein as display modules 18) and one or more optical systems such as optical systems 20. Projectors 18 may be mounted in a support structure such as housing 12. Each projector 18 may emit display light 28 that is redirected towards a user's eye at eye box 24 using an associated one of optical systems 20. Display light 28 may be, for example, visible light (e.g., including wavelengths from 400-700 nm) that contains and/or represents display content such as a scene or object (e.g., as modulated onto the display light using the display data provided by the control circuitry to the display module).

The operation of device 10 (sometimes referred to as glasses 10, eyewear 10, head-mounted device 10, etc.) may be controlled using control circuitry 14. Control circuitry 14 may include storage and processing circuitry for controlling the operation of device 10. Control circuitry 14 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 14 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 14 and run on processing circuitry in control circuitry 14 to implement operations for device 10 (e.g., data gathering operations, operations involving the adjustment of components using control signals, image rendering operations to produce image content to be displayed for a user, etc.).

Device 10 may include input-output circuitry such as input-output devices 68. Input-output devices 68 may be used to allow data to be received by device 10 from external equipment (e.g., a tethered computer, a portable device such as a handheld device or laptop computer, or other electrical equipment) and to allow a user to provide head-mounted device 10 with user input. Input-output devices 68 may also be used to gather information on the environment in which device 10 (e.g., head-mounted device 10) is operating. Output components in devices 68 may allow device 10 to provide a user with output and may be used to communicate with external electrical equipment. Input-output devices 68 may include sensors and other components 16 (e.g., image sensors for gathering images of real-world objects that are digitally merged with virtual objects on display 60 in device 10, accelerometers, depth sensors, light sensors, haptic output devices, speakers, batteries, wireless communications circuits for communicating between device 10 and external electronic equipment, etc.).

Projectors 18 may include liquid crystal displays, organic light-emitting diode displays, laser-based displays, or displays of other types. Projectors 18 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce display light 28, etc.

Optical systems 20 may form lenses that allow a viewer (e.g., a viewer's eye at eye box 24) to view images on display(s) 60. There may be two optical systems 20 (e.g., for forming left and right lenses) associated with respective left and right eyes of the user. A single display 60 may produce images for both eyes, or a pair of displays 60 may be used to display images. In configurations with multiple displays (e.g., left and right displays), the focal length and positions of the lenses formed by system 20 may be selected so that any gap present between the displays will not be visible to a user (e.g., so that the images of the left and right displays overlap or merge seamlessly).

If desired, optical system 20 may contain components (e.g., an optical combiner formed from reflective components, diffractive components, refractive components, a waveguide, a direct view optical combiner, and/or other optics) to allow real-world light 26 (sometimes referred to as world light 26, ambient light 26, outside light 26, etc.) from real-world (external) objects such as real-world (external) object 22 to be combined optically with displayed images (e.g., virtual, computer-generated images, camera-captured images, and/or other displayed images) in display light 28. Light 30 that reaches eye box 24 may include only display light 28, may include only outside light 26, or may include both display light 28 and outside light 26, depending on the mode in which display 60 is operating. In this type of system, which is sometimes referred to as an augmented reality system, a user of device 10 may view both real-world content (e.g., world light 26 from object 22) and display content from projectors 18 that is overlaid on top of the real-world content. Real-world light 26 may include ambient light as well as display light generated by external displays (e.g., a cellular telephone display, a tablet computer display, or other suitable display that is viewed through glasses 10), whereas display light 28 may originate from projectors 18 within device 10. Display light 28 may include computer-generated display content as well as camera-captured display content. In camera-based augmented reality systems, a camera captures real-world images of object 22 and this content is digitally merged with virtual content at optical system 20.

Device 10 may, if desired, include wireless circuitry and/or other circuitry to support communications with a computer or other external equipment (e.g., a computer that supplies display 60 with display content). During operation, control circuitry 14 may supply image content to display 60. The content may be remotely received (e.g., from a computer or other content source coupled to device 10) and/or may be generated by control circuitry 14 (e.g., text, other computer-generated content, etc.). The content that is supplied to display 60 by control circuitry 14 may be viewed by a viewer at eye box 24.

If desired, device 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 14 may process the optical sensor data to identify and track the direction of the user's gaze in real time. Control circuitry 14 may perform any desired operations based on the tracked direction of the user's gaze over time. This is merely illustrative. If desired, device 10 may not include any gaze tracking sensors.

Optical system 20 may include any desired optics for directing display light 28 and outside light 26 to eye box 24. In some implementations, optical system 20 includes left and right waveguides that provide left and right display light to respective left and right eye boxes. The waveguides propagate the display light via total internal reflection. Each waveguide may include an input coupler that couples display light into the waveguide, an output coupler that couples the display light out of the waveguide, and optionally a cross coupler or pupil expander for redirecting and/or expanding the display light propagating within the waveguide via total internal reflection. The input coupler, output coupler and/or cross coupler may include diffractive structures such as surface relief gratings, volume holograms, metagratings, or other diffractive gratings, reflective structures such as louvered mirrors, and/or any other desired optical coupling structures.

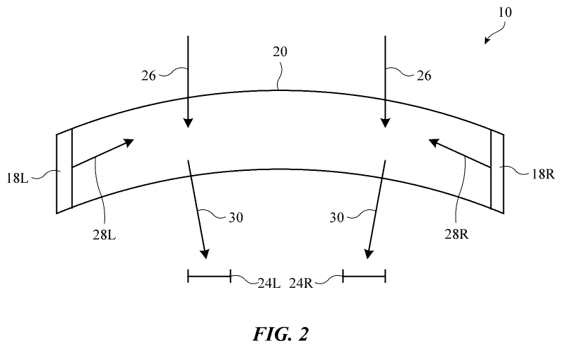

In other implementations, which are described herein as an example, optical system 20 may include optics arranged in a birdbath architecture. FIG. 2 is a top view showing an illustrative example of optical system 20. Device 10 may include a first (left) projector 18L that emits display light 28L into optical system 20 (e.g., images for view by the user's left eye). Device 10 may include a second (right) projector 18R that emits display light 28R (e.g., images for view by the user's right eye).

Optical system 20 may redirect display light 28L to left eye box 24L via three or more reflections within optical system 20. Optical system 20 may also redirect display light 28R to right eye box 24R via three or more reflections within optical system 20. Optical system 20 may also perform one or more refractions on display light 28L and display light 28R if desired. At the same time, optical system 20 may transmit outside light 26 to eye boxes 24L and 24R (e.g., for overlaying the outside light 26 with virtual images in display light 28L and 28R).

Projectors 18L and 18R may include respective emissive display panels and are therefore sometimes referred to herein as display panels 18L and 18R. Each display panel may include an array of pixels (e.g., emissive light sources that each emit a respective pixel of the image light). The pixels may be formed from light-emitting diodes, organic light-emitting diodes, or lasers, as examples. If desired, display panel 18L may be replaced with two adjacent emissive display panels (e.g., for emitting two respective channels of display light 28L) and/or display panel 18R may be replaced with two adjacent emissive display panels (e.g., for emitting two respective channels of display light 28R).

Optical system 20 of device 10 may have one or more adjustable tint layers for darkening ambient light to improve the viewability of display content on displays 60. Additionally, optical system 20 may include one or more adjustable haze layers for diffusing ambient light to further improve the viewability of display content on displays 60 by blurring objects in the background. If desired, the tint and haze layers in optical system 20 may be switchable so that device 10 can switch between a dark mode (e.g., in which display content on displays 60 is viewed while the haze and tint layers darken and diffuse ambient light) and a see-through or transparent mode (e.g., in which the haze and tint layers are clear and ambient light is not diffused or darkened). This allows viewers to easily switch between real-world interactions and immersive viewing experiences without removing device 10, if desired.

In some arrangements, optical system 20 may be configured to transmit display light from a target display in an external electronic device (e.g., a cellular telephone display, a tablet computer display, a laptop computer display, and/or any other external display). This may be especially beneficial in scenarios where the display content on device 10 is provided by or controlled using the external electronic device. In these types of arrangements, the user may need to interact with the external electronic device while wearing the head-mounted display. For example, the user may use the display on the external electronic device to select or adjust the display content that the user is viewing on displays 60. By using optical systems 20 in device 10 that are optimized for viewing the external display while darkening and diffusing ambient light, the user can view bright display content on both display 60 of device 10 as well as the display of an external electronic device, without the interference or distraction of ambient light.

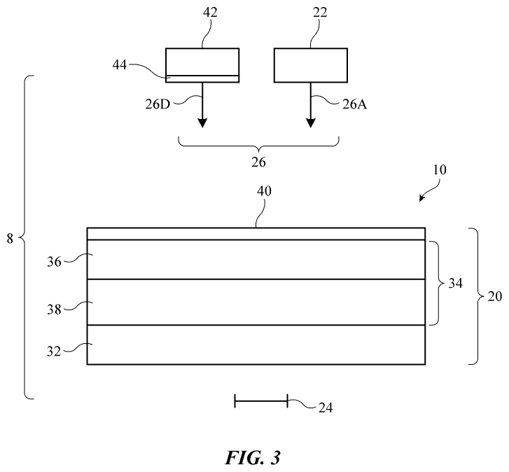

FIG. 3 is a diagram of an illustrative optical system 20 that may be configured to darken and diffuse ambient light to improve viewability of display content on displays 60 of device 10. As shown in FIG. 3, system 8 may include device 10, device 42, and external objects such as object 22. Device 10 may be head-mounted eyewear such as a pair of sunglasses, a pair of glasses, a head-mounted device, a pair of goggles, and/or any other suitable head-mounted device.

Optical system 20 may form lenses that allow a viewer (sometimes referred to herein as a user of device 10) to view external objects through optical system 20. For example, a user wearing device 10 may view external objects in the environment such as electronic device 42 (e.g., an electronic device having a display such as display 44) and other objects 22 in the environment through optical system 20. Outside light 26 that is viewed through optical system 20 may include display light 26D that is emitted from displays such as display 44 and may include ambient light 26A such as sunlight, light from external light sources, and/or other ambient light (e.g., light that allows external objects such as object 22 to be viewable).

Only a single optical system 20 is shown in FIG. 3, but device 10 may include any suitable number of optical systems 20. Device 10 may, for example, include a left optical system 20 aligned with a viewer's left eye and a right optical system 20 aligned with a viewer's right eye. Arrangements in which device 10 includes left and right optical systems 20 for respective left and right eyes are sometimes described herein as an example. If desired, portions of optical systems 20 may be permanently or removably attached to device 10. For example, optical systems 20 may include one or more clip-on lenses, magnetically attached lenses, and/or other detachable lenses that can be selectively attached to and removed from device 10.

Optical system 20 may include an optical combiner such as optical combiner 32 and one or more light modulator layers such as light modulator layer 34. Optical combiner 32 may be formed from reflective components, diffractive components, refractive components, a waveguide, a direct view optical combiner, and/or other optics that allow outside light 26 to be combined optically with display light 28 (FIG. 1). Arrangements in which optical combiner 32 has a birdbath architecture are sometimes described herein as an illustrative example, but this is merely illustrative. If desired, optical combiner 32 may have a waveguide architecture or any other suitable architecture.

Adjustable light modulator layer 34 may include one or more switchable and/or static light modulating layers that modify optical characteristics of outside light 26 (e.g., light transmission, reflection, absorption, haze, and/or other optical characteristics of outside light 26 such as display light 26D and ambient light 26A). Light modulator layer 34 may include a haze layer such as adjustable haze layer 38 and a tint layer such as adjustable tint layer 36. Haze layer 38 and tint layer 36 may be separate layers or may be implemented in a combined structure that has both haze and tint capabilities. In arrangements where haze layer 38 and tint layer 36 are implemented using separate structures, each layer may be independently adjusted (e.g., tint layer 36 can be adjusted between clear and dark states and haze layer 38 can be adjusted between clear and hazy states independently of one another). Tint layer 36 may be an electrochromic tint layer or a liquid crystal tint layer (e.g., polymer network liquid crystal, polymer-dispersed liquid crystal, polymer-stabilized liquid crystal, twisted-nematic liquid crystal, or other suitable liquid crystal). Haze layer 38 may be a liquid crystal layer such as polymer-dispersed liquid crystal, twisted-nematic liquid crystal, and/or any other suitable liquid crystal layer or haze layer.

In the example of FIG. 3, haze layer 38 is interposed between optical combiner 32 and tint layer 36. This example is merely illustrative. If desired, tint layer 36 may be interposed between haze layer 38 and optical combiner 32. Other stack-up orders may be used, if desired.

If desired, a user may wear device 10 to protect his or her eyes from sunlight and/or to view display content on display 60 (FIG. 1). While wearing device 10 for sun protection and/or for viewing display content on display 60, the user may wish to use an electronic device such as electronic device 42. Electronic device 42 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 3, device 42 is a portable device such as a cellular telephone, media player, tablet computer, laptop computer, wrist device, or other portable computing device. Other configurations may be used for device 42 if desired. The example of FIG. 3 is merely illustrative.

In the example of FIG. 3, device 42 includes a display such as display 44 mounted in a housing. Display 44 may be a touch screen display that incorporates a layer of conductive capacitive touch sensor electrodes or other touch sensor components or may be a display that is not touch-sensitive.

Control circuitry in device 42 may be used to run software on device 42 such as operating system code and applications. During operation of device 42, the software running on the control circuitry may display images on display 44 using an array of pixels in display 44. While displaying images, display 44 may emit display light 26D. Display 44 may be covered with a polarizer. The polarizer may be permanently attached to display 44 or may be part of a removable screen protector that can be selectively attached to and removed from display 44. The polarizer of device 42 may include one or more polarizer layers such as linear polarizer layers, one or more circular polarizer layers, one or more quarter wave plate layers, and/or one or more half wave plate layers. In some arrangements, the polarizer may include a linear polarizer and display light 26D may be linearly polarized light. In other arrangements, the polarizer may include a linear polarizer that is covered with a quarter wave plate. The quarter wave plate may convert the linearly polarized light received from the linear polarizer into circularly polarized display light 26D. These examples are merely illustrative. Device 42 may have other polarizer arrangements, if desired.

To protect the user's eyes from sunlight and/or to improve the viewability of display content on display 60 while also allowing the user to view electronic device displays such as display 44, optical system 20 of device 10 may include display-optimized lenses that reduce the brightness of ambient light 26A by a greater amount than light from other light sources such as display light 26D. Optical system 20 may include one or more polarizers, one or more quarter wave plates, and/or one or more light filters that are optimized for viewing a target display such as display 44. Because different types of displays have different color spectrums and different polarizer configurations, optical system 20 may include polarizer layers and light filter layers that are tailored to a given target display (e.g., optical system 20 may be tailored to the polarizer and emission spectrum of display 44, if desired). As used herein, “target display” may refer to any display that can be viewed through optical system 20, such as display 44 of device 42.

In some arrangements, device 42 may be used to adjust or control display content on device 10. For example, display 44 of device 42 may be used to display a menu, on-screen selectable options, and/or other information related to device 10, displays 60, and/or the display content that is being viewed on displays 60. In some scenarios, device 42 may be the source of display content that is displayed on display 60. Power and/or graphics processing for display 60 of device 10 may also be provided by device 42, if desired (e.g., through a wired or wireless connection). For example, display 60 may serve as a secondary and/or extended display for display 44 (e.g., in which display content on display 60 mirrors display content on display 44, in which display content on display 60 is streamed from or otherwise provided by device 42, and/or in which user input to device 42 is used to control display content on display 60). User input to device 42 (e.g., touch input to display 44, voice input to a microphone in device 42, and/or other input to device 42) may be used to adjust the display content on display 60 and/or to adjust other settings or operations of device 10. If the display content on display 44 is too dark due to the presence of inappropriately tinted lenses, the user would find it difficult to use device 42 while wearing device 10. By using an optical system such as optical system 20 that is optimized for viewing display 42 (e.g., lenses that transmit most or all of display light 26D while reducing the brightness of and diffusing ambient light 26A using tint layer 36 and haze layer 38 of light modulator layer 34), the user can view bright display content on display 44 and display 60 without the interference or distraction of ambient light 26A. This allows the user to use device 42 as a controller (e.g., a gaming controller, a remote control, etc.) for display 60 while wearing device 10.

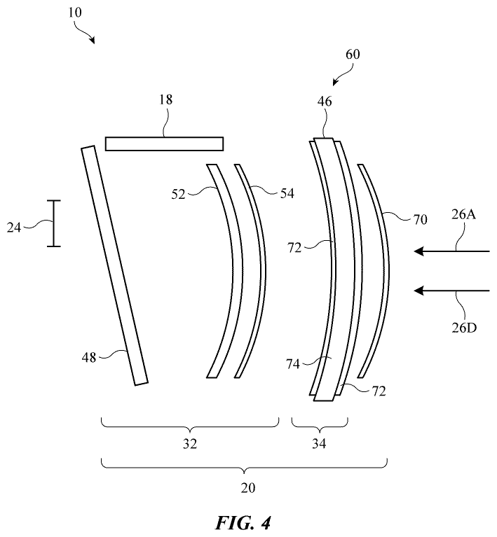

FIG. 4 is a side view of an illustrative optical system 20 for device 10. In the arrangement of FIG. 4, optical combiner 32 has a birdbath architecture. This is merely illustrative. If desired, optical combiner 32 may include waveguides and one or more input couplers and output couplers. The optical combiner arrangement of FIG. 4 is sometimes described herein as an illustrative example.

Optical combiner 32 may include a display module such as display module 18, a beam splitter such as polarizing beam splitter 48, a quarter wave plate such as quarter wave plate 52, and a mirror such as partial mirror 54. Display module 18 may be formed from organic light-emitting diode pixels, liquid crystal pixels, laser-based pixels, or pixels of other types. Display module 18 may include a polarizer, if desired, and may be configured to emit display light towards polarizing beam splitter 48. Polarizing beam splitter 48 may have a polarization axis that is matched to the polarization of display light 26D, if desired, to ensure that display light 26D can reach eye box 24 (e.g., to ensure that ambient light 26A is darkened more than display light 26D). For example, if display light 26D is linearly polarized along a given axis, then polarizing beam splitter 48 may include a linear polarizer that is matched to the given axis. If display light 26D is circularly polarized, polarizing beam splitter 48 may include a circular polarizer (e.g., a combination of a quarter wave plate and a linear polarizer).

Light modulator layer 34 may overlap optical combiner 32. In the example of FIG. 4, light modulator layer 34 may include a combined tint and haze layer 46 that is adjustable between a dark and diffused state (e.g., used when device 10 is in the dark mode) and a transparent state (e.g., used when device 10 is in the transparent state). Tint and haze layer 46 may include liquid crystal material 74 (polymer network liquid crystal, polymer-dispersed liquid crystal, polymer-stabilized liquid crystal, twisted-nematic liquid crystal, or other suitable liquid crystal), sandwiched between electrodes such as electrodes 72. To provide tint and haze layer 46 with tint capabilities, tint and haze layer 46 may include added dyes such as black dye so that layer 46 can both diffuse and darken ambient light 26A (e.g., without requiring a separate tint layer, if desired). Arrangements in which liquid crystal layer 74 is a polymer-dispersed liquid crystal layer are sometimes described herein as an example. Polymer-dispersed liquid crystal layers that incorporate black dyes are sometimes referred to as “normally black” polymer-dispersed liquid crystal layers.

Electrodes 72 may be used to control the state of polymer-dispersed liquid crystal material 74. Electrodes 72 may be implemented using a transparent conductive material such as indium tin oxide, indium zinc oxide, other transparent conductive oxide material, and/or a layer of metal that is sufficiently thin to be transparent. In some arrangements, a first electrode 72 may be a common electrode that receives a common electrode voltage (sometimes referred to as Vcom) and a second opposing electrode 72 may be a signal electrode that receives a signal electrode voltage (sometimes referred to as Vp).

One or both of electrodes 72 may be segmented, if desired, to independently control different regions of polymer-dispersed liquid crystal material 74. For example, one or both of electrodes 72 may be segmented into an array of rows and columns, an array of vertical strips, an array of horizontal strips, a set of concentric circles or other ring shapes, etc. This would allow some regions of polymer-dispersed liquid crystal material 74 to be clear while other regions of polymer-dispersed liquid crystal material 74 are dark and/or hazy. Arrangements in which a gradient voltage is applied across material 74 by applying a first voltage to a first electrode located along a first edge of layer 74 and applying a second voltage to a second electrode along a second edge of layer 74 may also be used, if desired.

Tint and haze layer 46 may be used to adjust the haze and tint of outside light 26. In particular, polymer-dispersed liquid crystal material 74 may be switchable between a clear state and one or more dark and hazy states. For example, electrodes 72 may be used to apply a controlled electric field (i.e., a field having a magnitude proportional to Vp-Vcom) across polymer-dispersed liquid crystal material 74 in layer 46. The electric field that is produced across polymer-dispersed liquid crystal material 74 causes a change in the orientation of the liquid crystals in polymer-dispersed liquid crystal material 74. This change in orientation of the liquid crystals may be used to control the amount of light 26 that passes through polymer-dispersed liquid crystal material 74 by controlling the amount of scattering that light 26 experiences as it passes through polymer-dispersed liquid crystal material 74. When no voltage is applied to electrodes 72, layer 46 may be hazy and dark. When a voltage is applied to electrodes 72, layer 46 may be fully transparent. This is merely illustrative, however. If layer 74 is formed from polymer network liquid crystal, for example, layer 74 may be clear when no voltage is applied and dark when a voltage is applied. This may be useful in arrangements where device 10 is intended to be clear most of the time. Arrangements in which device 10 is intended to be used mostly for dark display viewing and therefore uses polymer-dispersed liquid crystal material are sometimes described herein as an example.

As an example, when device 10 is operating in a dark display viewing mode for viewing content on display 60 (and/or when device 10 is being used for sun protection), the voltage applied to electrodes 72 may be turned off so that light 26 is scattered and darkened in polymer-dispersed liquid crystal material 74. This allows images on display 60 to appear crisp, clear, and bright against a dark, diffused background, without interference or distraction of ambient light 26A. Because of the increased haze in layer 74, objects 22 in the user's environment will be blurred and will therefore not distract the user from the content on display 60.

When device 10 is operating in a transparent mode so that the user can clearly view external objects 22 in the user's environment instead of or in addition to viewing display content on display 60, a voltage may be applied to electrodes 72 so that light 26 passes through polymer-dispersed liquid crystal material 74 unaltered to reach eye box 24. When device 10 is in the transparent mode, objects in the user's environment such as object 22 will appear crisp and clear when viewed through optical system 20.

If desired, an additional filter such as light filter 70 may optionally be incorporated into optical system 20. For example, light filter 70 may be located on an outer surface of optical system 20 (e.g., an outer surface of light modulator layer 34). Polarizer 48 as well as light filter 70 may have properties that are selected based on the characteristics of a given target display. In particular, the polarization properties of polarizer 48 may be selected based on the polarization of display light 26D, and the transmission spectrum of light filter 70 may be based on the color spectrum of display light 26D. Light filter 70 may be configured to transmit more display light 26D than ambient light 26A. In particular, light filter 70 may have a transmission spectrum that reduces the brightness of ambient light 26A (e.g., by blocking certain wavelengths of light that are present in ambient light 26A but not present in display light 26D) without reducing (or without significantly reducing) the brightness of display light 26D (e.g., by transmitting certain wavelengths of light that are present in display light 26D and blocking certain wavelengths of light that are not present in display light 26D). Light filter 70 may be a reflective filter (e.g., a dichroic filter) that reflects light that is not transmitted through filter 70 or may be an absorptive filter that absorbs light that is not transmitted through filter 70. The use of filter 70 is merely illustrative. If desired, filter 70 may be omitted or may be incorporated elsewhere in optical system 20. Light filter 70 may, if desired, be a clip-on lens or other removable lens that the user can selectively attach to device 10.

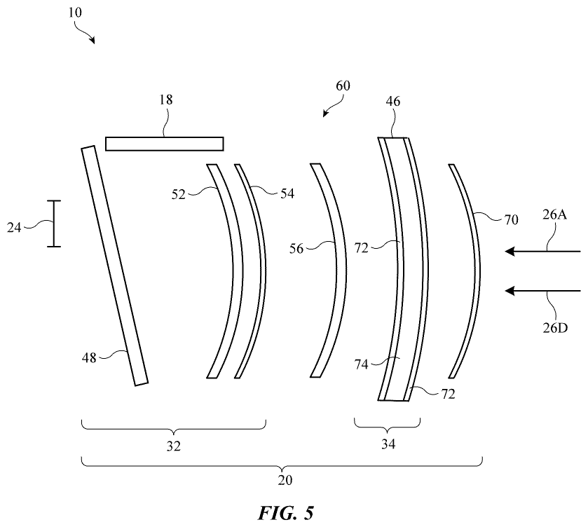

FIG. 5 shows another illustrative arrangement for optical system 20. FIG. 5 is similar to the example of FIG. 4 with the exception that FIG. 5 includes an additional quarter wave plate such as quarter wave plate 56 interposed between optical combiner 32 and light modulator layer 34. Quarter wave plate 56 may be configured to suppress specular reflections from tint and haze layer 46. This in turn helps suppress ghost artifacts that might otherwise be present in display content on display 60.

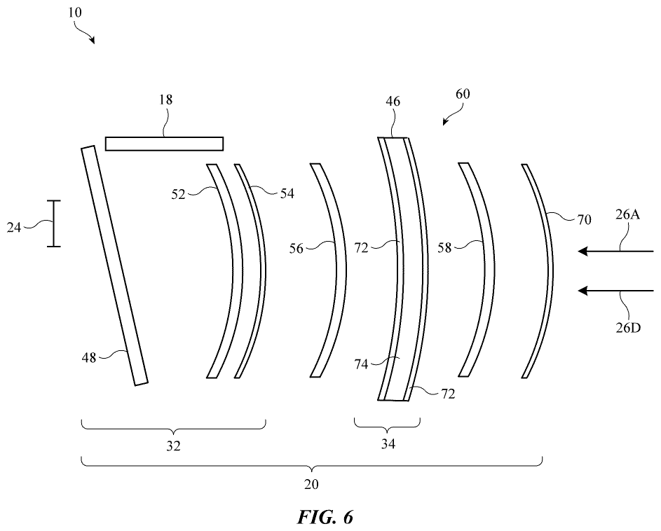

While the arrangement of FIG. 5 may be helpful for suppressing ghost artifacts in display content on display 60, display light 26D may be dimmed at the same level as ambient light 26A. This can be counteracted using an arrangement of the type shown in FIG. 6.

FIG. 6 shows another illustrative arrangement for optical system 20. FIG. 6 is similar to the example of FIG. 5 with the exception that FIG. 6 includes an additional quarter wave plate such as quarter wave plate 58. Tint and haze layer 46 may be interposed between quarter wave plate 56 and quarter wave plate 58. The addition of quarter wave plate 58 allows ambient light 26A to be darkened more than display light 26D.

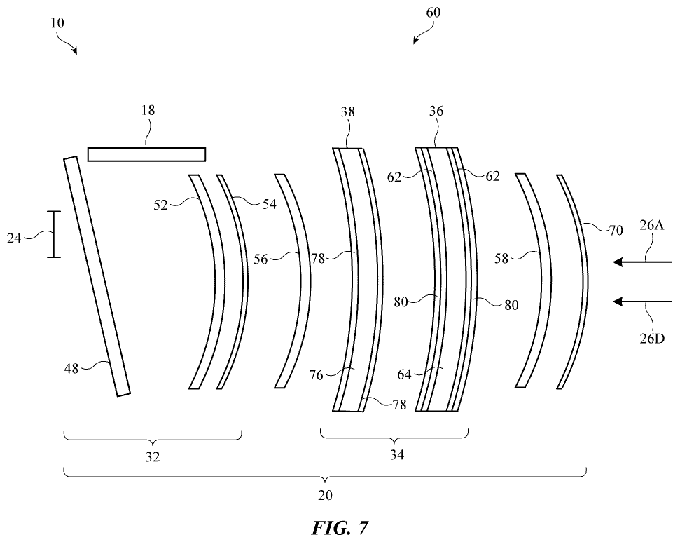

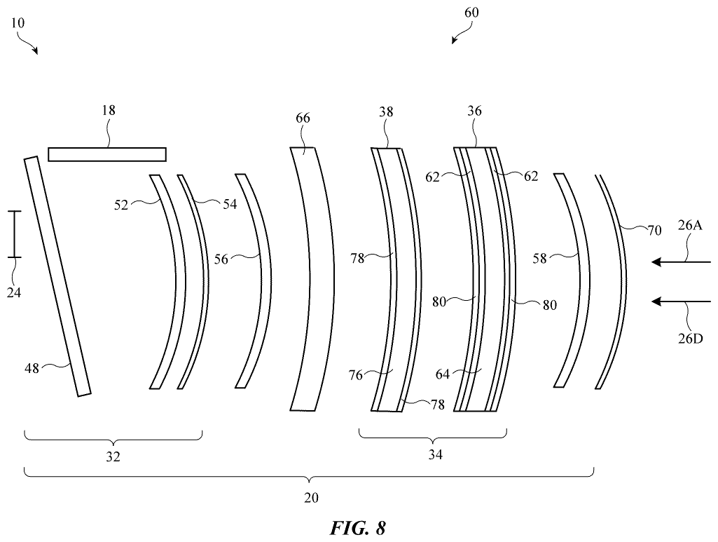

The examples of FIGS. 4, 5, and 6 in which haze and tint is adjusted using a common liquid crystal layer such as tint and haze layer 46 is merely illustrative. If desired, haze may be adjusted using a first light modulator layer and tint may be adjusted using a second light modulator layer. FIGS. 7 and 8 show illustrative examples of optical systems 20 that use distinct light modulator layers to independently adjust tint and haze.

In the example of FIG. 7, optical system 20 includes optical combiner 32 and light modulator layers 34. Light modulator layers 34 may be interposed between first and second quarter wave plates such as quarter wave plate 56 and quarter wave plate 58. Quarter wave plate 56 may be configured to suppress ghost artifacts in display content on display 60, while the presence of additional quarter wave plate 58 allows ambient light 26A to be darkened more than display light 26D. A light filter such as light filter 70 that has passbands corresponding to the emission spectrum of display 44 may optionally be added to the exterior of optical system 20, if desired.

Light modulator layers 34 may include adjustable haze layer 38 and adjustable tint layer 36. Haze layer 38 may include a layer of liquid crystal material such as polymer-dispersed liquid crystal layer 76 sandwiched between electrodes 78.

Electrodes 78 may be used to control the state of polymer-dispersed liquid crystal layer 76. Electrodes 78 may be implemented using a transparent conductive material such as indium tin oxide, indium zinc oxide, other transparent conductive oxide material, and/or a layer of metal that is sufficiently thin to be transparent. In some arrangements, a first electrode 78 may be a common electrode that receives a common electrode voltage (sometimes referred to as Vcom) and a second opposing electrode 78 may be a signal electrode that receives a signal electrode voltage (sometimes referred to as Vp).

One or both of electrodes 78 may be segmented, if desired, to independently control different regions of polymer-dispersed liquid crystal layer 76. For example, one or both of electrodes 78 may be segmented into an array of rows and columns, an array of vertical strips, an array of horizontal strips, a set of concentric circles or other ring shapes, etc. This would allow some regions of polymer-dispersed liquid crystal layer 76 to be clear while other regions of polymer-dispersed liquid crystal layer 76 are hazy. Arrangements in which a gradient voltage is applied across material 76 by applying a first voltage to a first electrode located along a first edge of layer 76 and applying a second voltage to a second electrode along a second edge of layer 76 may also be used, if desired.

Adjustable haze layer 38 may be used to adjust the haze of outside light 26. In particular, polymer-dispersed liquid crystal layer 76 may be switchable between a clear state and one or more hazy states. For example, electrodes 78 may be used to apply a controlled electric field (i.e., a field having a magnitude proportional to Vp-Vcom) across polymer-dispersed liquid crystal layer 76 in layer 38. The electric field that is produced across polymer-dispersed liquid crystal layer 76 causes a change in the orientation of the liquid crystals in polymer-dispersed liquid crystal layer 76. This change in orientation of the liquid crystals may be used to control the amount of light 26 that passes through polymer-dispersed liquid crystal layer 76 by controlling the amount of scattering that light 26 experiences as it passes through polymer-dispersed liquid crystal layer 76. When no voltage is applied to electrodes 78, layer 38 may be hazy. When a voltage is applied to electrodes 78, layer 38 may be fully clear. This is merely illustrative, however. If layer 76 is formed from polymer network liquid crystal, for example, layer 76 may be clear when no voltage is applied and dark when a voltage is applied. This may be useful in arrangements where device 10 is intended to be clear most of the time. Arrangements in which device 10 is intended to be used mostly for dark display viewing and therefore uses polymer-dispersed liquid crystal material are sometimes described herein as an example.

For example, when device 10 is operating in a dark display viewing mode for viewing content on display 60 (and/or when device 10 is being used for sun protection), the voltage applied to electrodes 78 may be turned off so that light 26 is scattered in polymer-dispersed liquid crystal layer 76. This allows images on display 60 to appear crisp, clear, and bright against a diffused background. Because of the increased haze in layer 38, objects 22 in the user's environment will be blurred and will therefore not distract the user from the content on display 60.

Adjustable tint layer 36 may include a layer of liquid crystal material such as twisted-nematic liquid crystal layer 64 (or other suitable liquid crystal layer) sandwiched between electrodes 62 and between outer polarizers 80 (e.g., linear polarizers). If desired outer polarizer 80 (e.g., facing away from eye box 24) may be an absorptive front polarizer or may be a reflective front polarizer (e.g., reflecting 50% of ambient light or other suitable amount of ambient light) to provide a reflective appearance on the outer surface of device 10.

Electrodes 62 may be used to control the state of twisted-nematic liquid crystal layer 64. Electrodes 62 may be implemented using a transparent conductive material such as indium tin oxide, indium zinc oxide, other transparent conductive oxide material, and/or a layer of metal that is sufficiently thin to be transparent. In some arrangements, a first electrode 62 may be a common electrode that receives a common electrode voltage (sometimes referred to as Vcom) and a second opposing electrode 62 may be a signal electrode that receives a signal electrode voltage (sometimes referred to as Vp).

One or both of electrodes 62 may be segmented, if desired, to independently control different regions of twisted-nematic liquid crystal layer 64. For example, one or both of electrodes 62 may be segmented into an array of rows and columns, an array of vertical strips, an array of horizontal strips, a set of concentric circles or other ring shapes, etc. This would allow some regions of twisted-nematic liquid crystal layer 64 to be clear while other regions of twisted-nematic liquid crystal layer 64 are dark. Arrangements in which a gradient voltage is applied across material 64 by applying a first voltage to a first electrode located along a first edge of layer 64 and applying a second voltage to a second electrode along a second edge of layer 64 may also be used, if desired.

Tint layer 36 may be used to adjust the tint of outside light 26. In particular, twisted-nematic liquid crystal layer 64 may be switchable between a clear state and one or more dark states. For example, electrodes 62 may be used to apply a controlled electric field (i.e., a field having a magnitude proportional to Vp-Vcom) across twisted-nematic liquid crystal layer 64 in layer 36. The electric field that is produced across twisted-nematic liquid crystal layer 64 causes a change in the orientation of the liquid crystals in twisted-nematic liquid crystal layer 64. This change in orientation of the liquid crystals may be used to control the amount of light 26 that passes through twisted-nematic liquid crystal layer 64 by controlling the amount of scattering that light 26 experiences as it passes through twisted-nematic liquid crystal layer 64. When no voltage is applied to electrodes 62, layer 36 may be dark. When a voltage is applied to electrodes 62, layer 36 may be fully transparent.

For example, when device 10 is operating in a dark display viewing mode for viewing content on display 60, the voltage applied to electrodes 62 may be turned off so that light 26 is scattered in twisted-nematic liquid crystal layer 64. This allows images on display 60 to appear crisp, clear, and bright against a dark background. Additionally, because of the increased haze in layer 38, objects 22 in the user's environment will be blurred and will therefore not distract the user from the content on display 60.

While the presence of first and second quarter wave plates 56 and 58 helps suppress ghost artifacts while also allowing ambient light 26A to be darkened more than display light 26D, some bloom artifacts may be visible in display content on display 60 if care is not taken. This can be counteracted using an arrangement of the type shown in FIG. 8.

FIG. 8 shows another illustrative arrangement for optical system 20. FIG. 8 is similar to the example of FIG. 7 with the exception that FIG. 8 includes an additional linear polarizer 66 interposed between quarter wave plate 56 and haze layer 38. Polarizer 66 may be matched to the polarization of polarizers 80, if desired.

The combination of quarter wave plate 56 and linear polarizer 66 may be configured to suppress circularly polarized light that exits combiner 32, thereby suppressing bloom artifacts in display content on display 60. Additionally, since the polarized light that exits combiner 32 is extinguished before it interacts with haze layer 36, there is no scattering back of light from haze layer 36, thereby suppressing ghost artifacts in addition to bloom artifacts. The presence of quarter wave plate 58 allows ambient light 26A to be darkened more than display light 26D.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. Eyewear, comprising:
a display configured to produce display content; and
an optical system through which the display content is viewable from an eye box, wherein the optical system comprises:
an optical combiner;
an adjustable tint layer; and
an adjustable haze layer.

2. The eyewear defined in claim 1 wherein the adjustable haze layer is interposed between the optical combiner and the adjustable tint layer.

3. The eyewear defined in claim 1 wherein the adjustable haze layer comprises a polymer-dispersed liquid crystal layer.

4. The eyewear defined in claim 1 wherein the adjustable tint layer is selected from the group consisting of: a twisted-nematic liquid crystal layer and an electrochromic layer.

5. The eyewear defined in claim 1 wherein the adjustable tint layer and the adjustable haze layer are independently adjustable.

6. The eyewear defined in claim 1 further comprising a quarter wave plate interposed between the adjustable haze layer and the optical combiner.

7. The eyewear defined in claim 6 further comprising an additional quarter wave plate, wherein the adjustable tint layer and the adjustable haze layer are interposed between the quarter wave plate and the additional quarter wave plate.

8. The eyewear defined in claim 7 further comprising a linear polarizer interposed between the quarter wave plate and the adjustable haze layer.

9. The eyewear defined in claim 8 further comprising a light filter on an outer surface of the optical system, wherein the light filter has passbands that correspond to the emission spectrum of an external display.

10. The eyewear defined in claim 1 wherein the optical combiner comprises a polarizing beam splitter, a quarter wave plate, and a half mirror.

11. A pair of glasses, comprising:
a display configured to produce display content; and
an optical system through which ambient light and the display content are viewable from an eye box, wherein the optical system comprises:
an optical combiner; and
an adjustable light modulator layer configured to diffuse and darken the ambient light when the display is presenting the display content.

12. The pair of glasses defined in claim 11 wherein the adjustable light modulator layer comprises a polymer-dispersed liquid crystal layer.

13. The pair of glasses defined in claim 12 wherein the polymer-dispersed liquid crystal layer comprises black dye.

14. The pair of glasses defined in claim 13 further comprising a quarter wave plate interposed between the optical combiner and the adjustable light modulator layer.

15. The pair of glasses defined in claim 13 further comprising an additional quarter wave plate, wherein the adjustable light modulator layer is interposed between the quarter wave plate and the additional quarter wave plate.

16. A head-mounted device configured to be controlled by an electronic device having a display that emits display light, the head-mounted device comprising:
a display module configured to produce display content; and
an optical system through which ambient light, the display light, and the display content are viewable from an eye box, wherein the optical system comprises:
an optical combiner; and
an adjustable light modulator layer configured to diffuse and darken the ambient light when the display is presenting the display content, wherein the display light is darkened less than the ambient light.

17. The head-mounted device defined in claim 16 wherein the adjustable light modulator layer comprises a polymer-dispersed liquid crystal layer with added dye.

18. The head-mounted device defined in claim 16 wherein the adjustable light modulator layer comprises:
a polymer-dispersed liquid crystal layer configured to diffuse the ambient light; and
a twisted-nematic liquid crystal layer configured to darken the ambient light.

19. The head-mounted device defined in claim 16 wherein the adjustable light modulator layer is interposed between first and second quarter wave plates.

20. The head-mounted device defined in claim 16 wherein the optical system comprises a light filter having passbands corresponding to an emission spectrum of the display.
